(19) United States
(12) Patent Application Publication
(10) Pub. No.: US 2011/0188618 A1
(43) Pub. Date: Aug. 4, 2011

(54) RF/DIGITAL SIGNAL-SEPARATING GNSS RECEIVER AND MANUFACTURING METHOD

(76) Inventor: Walter J. Feller, Airdrie (CA)

(21) Appl. No.: 13/019,866

(22) Filed: Feb. 2, 2011

Related U.S. Application Data
(60) Provisional application No. 61/300,750, filed on Feb. 2, 2010.

(51) Int. Cl. H04B 1/10

(52) U.S. Cl. 375/346

(57) ABSTRACT

An RF/digital signal-separating receiver is provided for GNSS and other RF signals. The receiver includes a first master antenna and a second slave antenna, which are positioned in spaced relation for directional, radio compass applications. First and second downconverters and first and second ADCs are located under the first and second antennas in analog signal areas, which configuration minimizes cross-coupling RF signals from the antennas and reduces noise. The first and second ADSs are connected to respective first and second correlators in a digital signal location, which is centrally located relative to the antennas. The correlators are connected to a microprocessor for computing distances for the received signals, from which the receiver's orientation or attitude is determined. A method of manufacturing receivers with this configuration is also disclosed.

### CROSS-REFERENCE TO RELATED APPLICATION

This application claims priority in U.S. Provisional Patent Application No. 61/300,750, filed Feb. 2, 2010, which is incorporated herein by reference.

### BACKGROUND OF THE INVENTION

1. Field of the Invention

The present invention relates generally to RF/digital receivers, and in particular to a signal-separating configuration for GNSS multi-antenna directional receivers and a receiver manufacturing method, which provides more accurate data in a more compact and economical size than previous GNSS-based heading devices.

2. Description of the Related Art

Global navigation satellite system (GNSS) guidance and control are widely used for vehicle and personal navigation and a variety of other uses involving precision location and machine control in geodesic reference systems. GNSS, which includes the Global Positioning System (GPS) and other satellite-based positioning systems, has progressed to sub-centimeter accuracy with known correction techniques, including a number of commercial satellite-based augmentation systems (SBASs).

GNSS guidance devices currently come in a variety of forms and function in a variety of different ways. For instance, the typical commercial GNSS guidance device located in a standard vehicle contains a receiver, an antenna, a graphical interface to instruct the vehicle operator where to go, and a processor, e.g., a central processing unit (CPU), for running calculations and processing requests.

Other uses for GNSS guidance include using the GNSS device as a bearing device or directional receiver, i.e. a multi-antenna directional receiver. The GNSS system can be used to determine heading information for a host system, such as a vehicle or a piece of equipment. Typically a GNSS directional receiver has a centrally located receiver and two or more separated antennas with low noise amplifiers (LNAs) to detect the phase differences among the carrier signals from GNSS satellites in various constellations, of which at least four satellites are visible at any given time for calculating GNSS-based position and heading fixes. Given the positions of the satellite, the position of the antenna, and the phase difference, the orientation of the two antennas can be computed. Additional antennas may be added to provide multiple readings with respect to each satellite, allowing three-dimensional (3D) position and heading solutions for the GNSS-equipped vehicle. A GNSS directional receiver is not subject to magnetic declination as a magnetic directional receiver is, and doesn't need to be reset periodically like a gyrodirectional receiver. It is, however, subject to multipath effects, which susceptibility is addressed by the present invention.

A potential performance-related receiver design problem relates to cross-coupling between the radio frequency (RF) signals from either or both of the two antennas; the master and the slave. This creates an error in the heading and position as the cross-coupled signal appears as a delay in time which smears the correlation peak and makes it more difficult to resolve the exact range to the satellite. This can also create a reduction in signal to noise ratio (SNR) if the cross-coupled signals cause a cancellation effect.

Another potential performance-related receiver design problem relates to digital signals being inherently noisy for RF as they have fast rising edges which have high harmonics content. These high harmonics can land in either the intermediate frequency (IF) or the RF frequency bands and increase the noise, thereby impairing the tracking of the desired signals. Still further, routing of the RF coaxial cables can create significant interference as they can pick up the digital harmonics and impair the signal tracking If these signals are digital (especially low-voltage differential signal (LVDS)) they will not be as sensitive to picking up noise. Moreover, LVDSs do not generate as many emissions as normal single-ended digital signals. Different drivers exist for creating and receiving LVDSs.

The present invention addresses the RF-digital signal interference problems with previous GNSS receivers. Heretofore, there has not been available a signal-isolating GNSS receiver with the advantages and features of the present invention.

### SUMMARY OF THE INVENTION

In the practice of the present invention an optimal layout is provided for a GNSS directional receiver, which is also referred to as a bearing or directional receiver device, resulting in a more efficient and accurate device for generating position and heading solutions based on GNSS signals. The present invention seeks to reduce or eliminate the signal interference and other shortcomings present in previous GNSS directional receiver devices currently available in the market.

### BRIEF DESCRIPTION OF THE DRAWINGS

The accompanying drawings illustrate the principles of the present invention and an exemplary embodiment thereof.

FIG. 1 is a diagram of a typical prior art GNSS directional receiver configuration.

FIG. 2 is a diagram of an embodiment of the present invention, displaying the configuration of an optimized GNSS directional receiver system.

DESCRIPTION OF THE PREFERRED EMBODIMENT

I. Introduction, Environment, and Preferred Embodiment

Generally, a preferred embodiment of the present invention consists of rearranging the layout typically used in GNSS directional receivers. By rearranging the location of the various devices, moving all of the RF signals underneath the antennas, and keeping a centrally-located area all digital, signal issues that typically impair signal tracking in the prior art are reduced or eliminated.

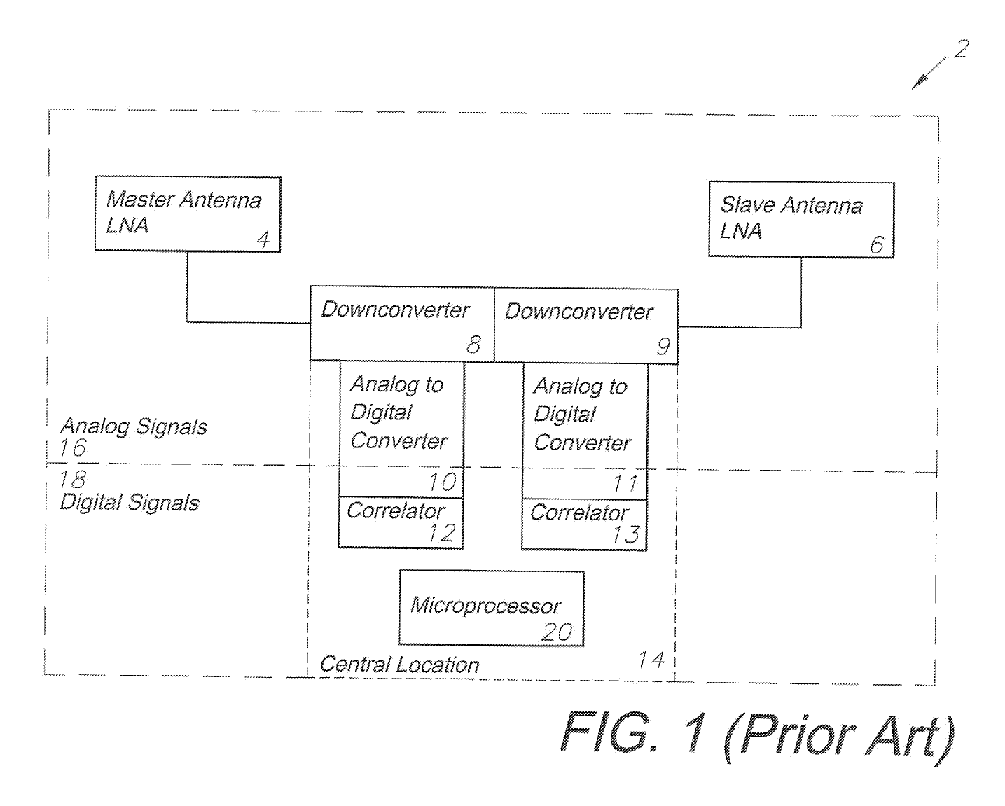

FIG. 1 is a block diagram showing a typical layout of a prior art GNSS directional receiver 2. The directional receiver 2 is separated into two sides, one for handling analog signals 16 and one for handling digital signals 18, with components for transferring signals from analog to digital in between and located in the central location 14. The typical directional receiver 2 has a master antenna combined with a low noise amplifier (LNA) 4 and a slave antenna with an LNA 6, but may have additional antennas and LNAs.

The antennas 4, 6 are connected to a pair of downconverters 8, 9, one for each antenna, located within the central location 14. These feed the downconverted analog signals to a pair of analog to digital converters (ADCs) 10, 11, which transform the signal from analog to digital and pass the signal from the analog side 16 to the digital side 18 of the directional receiver 2. A pair of correlators 12, 13 then receive the digital signals.

A microprocessor 20 is located within the central location 14 and receives the converted and correlated digital signal and processes it. As the signal passes through the various stages of transfer within the directional receiver 2, it picks up noise and other errors which may affect the value of the signal being interpreted by the microprocessor. The present invention addresses these potential performance-related problems.

The typical directional receiver 2 utilizes coaxial cable for interconnection between components, such as between the antennas 4, 6 and the ADCs 10, 11.

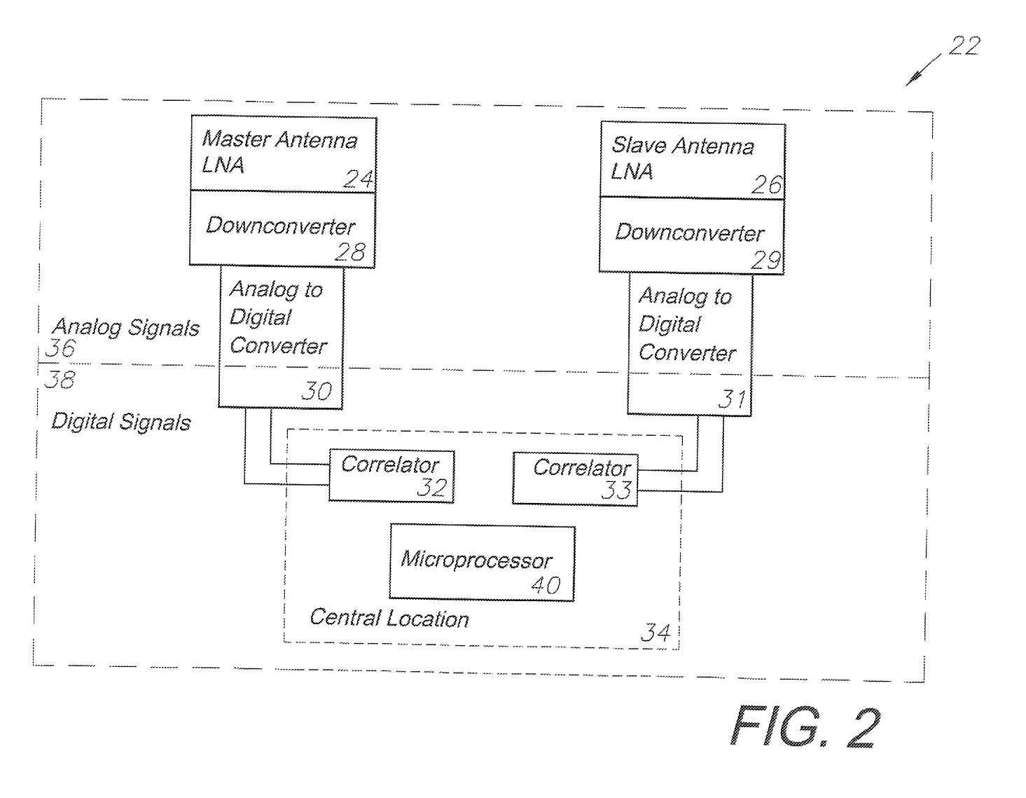

FIG. 2 is a diagram of a preferred embodiment of the present invention comprising a GNSS directional receiver 22. In the preferred embodiment, the components have been rearranged. The master antenna/LNA 24 and the slave antenna/LNA 26 are still aligned opposite of one another; however, the central location 34 has been moved entirely into the digital signal portion 38 of the directional receiver 22, and the rest remains on the analog portion 36. Each antenna 24, 26 is connected to a downconverter 28, 29 which feeds into an ADC 30, 31 in the same manner as the directional receiver of the prior art directional receiver 2. The ADCs 30, 31 are also connected to separate correlators 32, 33 located within the central location 34 with a microprocessor 40. The components function identically to the prior art directional receiver 2, but the arrangement of the components improves signal reception and processing.

The preferred embodiment 22 reduces the negative effects on signals prominent in the prior art directional receiver 2 as much as possible by moving all of the RF signals under the antennas and keeping the centrally-located area all digital. This is accomplished by moving the RF downconverters 28, 29 and ADCs 30, 31 under the antennas 24, 26. The digitized RF is brought into the GNSS digital section in the center using low-voltage differential drivers (LVDS), or other digital communication means.

Differential communication minimizes noise radiation and pick up and is recommended, but for short paths or shielded links a simple logic level communication is possible.

Separating the digital signals from the RF (IF and analog signals) as much as possible tends to minimize the digital harmonics causing an interference issue. If these signals are digital (especially LVDS) they will not be as sensitive to picking up noise. LVDS also will not generate as many emissions as a normal single-ended digital signal. This is due to the differential nature of the communication architecture. Having a balanced (a positive path and a negative path) signal creates a cancellation effect of radiated signals so the balanced signal does not radiate or pick up noise.

Whereas the typical directional receiver 2 in the existing art uses coaxial cable for component connection, the preferred embodiment 22 utilizes a group of LVDS lines. These lines may optionally be shielded. Shielding will reduce electronic noise and increase the signal performance of the preferred embodiment 22 over the prior art.

It will be appreciated that the components of the system 2 can be used for various other applications. Moreover, the subsystems, units and components of the system 2 can be combined in various configurations within the scope of the present invention. For example, the various units could be combined or subdivided as appropriate for particular applications. The system 2 is scalable as necessary for applications of various complexities. It is to be understood that while certain aspects of the disclosed subject matter have been shown and described, the disclosed subject matter is not limited thereto and endirectional receivers various other embodiments and aspects.

Having thus described the invention, what is claimed as new and desired to be secured by Letters Patent is:

1. A method of reducing digital noise in an RF/digital directional receiver, which method comprises the steps of:
providing first and second antennas positioned in spaced relation in said receiver;
providing first and second RF downconverters each connected to a respective antenna;
providing first and second analog-two-digital converters (ADCs) each connected to a respective downconverter;
locating said first and second downconverters and said first and second ADCs in an analog signal area under said first and second antennas respectively;
providing a digital signal central location relative to said first and second antennas;
providing first and second correlators in said central location and connected to said first and second ADCs respectively; and
providing a microprocessor in said central location and connected to and receiving input from said first and second correlators.

2. The method of reducing digital noise according to claim 1, which includes the additional steps of:
processing analog signals in said analog signal area under said first and second antennas; and
processing digital signals in said digital signal central location.

3. The method of reducing digital noise according to claim 1, which includes the additional step of providing first and second low noise amplifiers (LNAs) connected to said first and second antennas and to said first and second downconverters respectively.

4. The method of reducing digital noise according to claim 1, which includes the additional steps of:
providing first and second differential signal lines between said first and second ADCs in said analog signal area under said antennas and said first and second correlators in said digital signal central location respectively; and
communicating digital signals from said first and second ADCs to said first and second correlators over said first and second differential signal lines respectively.
